(19) United States
(12) Patent Application Publication
(10) Pub. No.: US 2019/0224788 A1
(43) Pub. Date: Jul. 25, 2019

(54) THE METHOD OF MANUFACTURING OF HEAT PIPES FOR HEATING SYSTEMS

(71) Applicants: Marek WÓJCIK, Bestwina (PL); Jerzy Zdzislaw GARUS, Czechowice-Dziedzice (PL)

(72) Inventors: Marek WÓJCIK, Bestwina (PL); Jerzy Zdzislaw GARUS, Czechowice-Dziedzice (PL); Janusz WÓJCIK, Bestwina (PL); Pawel WÓJCIK, Kraków (PL)

(21) Appl. No.: 16/313,072

(22) PCT Filed: Jun. 1, 2017
(86) PCT No.: PCT/PL2017/000060

§ 371 Date: Dec. 24, 2018

(30) Foreign Application Priority Data
Jun. 4, 2016 (PL) P.417434

(51) Int. Cl. B23P 15/26; F28D 15/02

(52) U.S. Cl. CPC B23P 15/26; B23P 2700/09; F28D 15/02

(57) ABSTRACT

The subject of the invention is the method of manufacturing of heat pipes for heating systems in which one end is previously tightly closed and subjected to the leak test of the joint performed at one of the ends and filled with gas from the refrigerating gases series. The method of manufacturing of heat pipes for heating systems in which one end is previously tightly sealed with a weld and subjected to the leak test of the joint, whereas the heat pipe itself is filled with gas from the refrigerating gases series, is characterised by that a single- or a multi-channel aluminium profile of up to 7 m in length of the cross-section of one internal channel within the range from 1 to 900 mm² is installed, ensuring tightness, with the other end in the dosing head with which the gas content of the channel/channels is pumped out until the vacuum of the value from 0 mbar to 100 mbar is obtained, and then the gas from the refrigerating gases series is introduced in such an amount that the two phases of the agent are present inside the channel, and then it is moved together with the dosing head to the area of the pressure welding machine electrode and at least one weld, and especially two welds are performed along the external surface of the profile in the distance from 10 to 1000 mm from the dosing head so that the internal channels are flattened and welded, and then the ends of the profile are sealed with a weld.

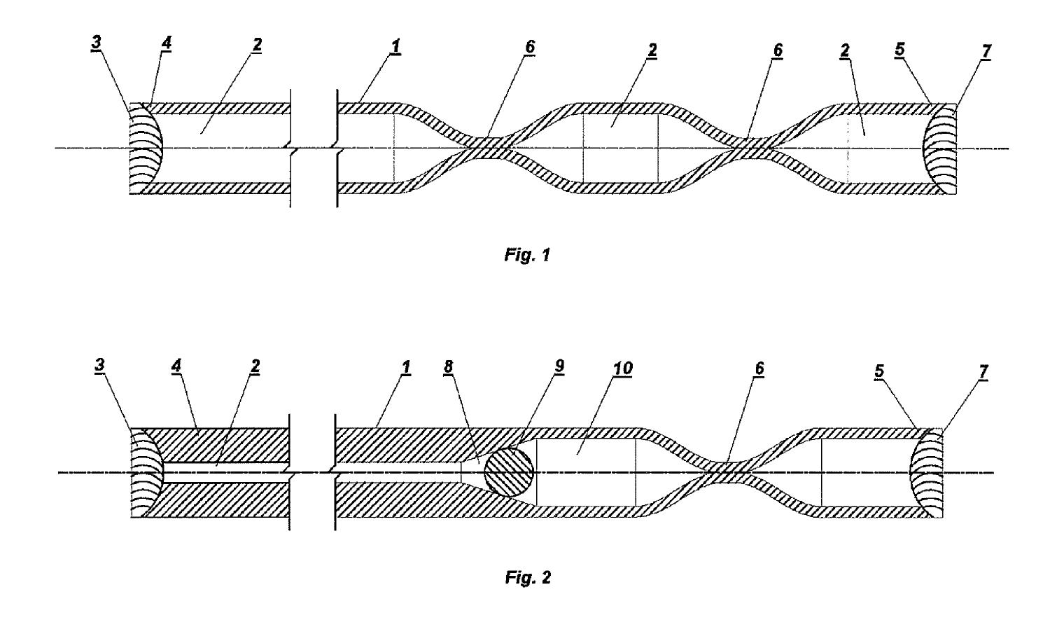

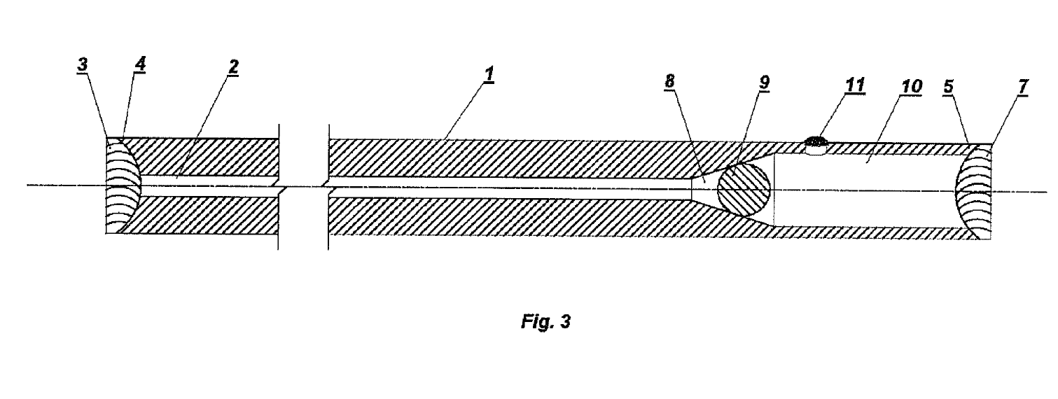

The subject of the invention is the method of manufacturing of heat pipes for heating systems in which one end is previously tightly closed and subjected to the leak test of the joint performed at one of the ends and filled with gas from the refrigerating gases series.

There are known methods of closing the internal channel in pressed aluminium profiles by welding, pressure welding or driving-in sealing elements using the elastic deformation of material, however, they do not provide a satisfactory level of tightness of the refrigerating gas closure and they cannot be used for heating systems, since the sealing elements based on the elastic deformation, used to date, do not guarantee long-lasting tightness, which period is specified for at least 10 years, in the heating element operating conditions at the constantly dynamically changing pressure of the agent closed inside the profile.

Similarly, application of aluminium welding for this purpose is a highly complicated process requiring a perfectly clean surface and the use of uncontaminated shielding gases, and sealing the gas from the refrigerating series without the use of additional processes preventing the contact of the gas with the weld is unfeasible at the current state of the art.

The most advantageous technology which can be applied for tight sealing of a heat pipe is the technology of aluminium profile welding that requires high electrical and force parameters, consisting in plasticisation of the contact surfaces and their mechanical bonding, which at dynamically changing dimensions in the operation cycle of the heat pipe element resulting from the thermal expansion does not guarantee the sealing tightness within time.

The purpose of the invention is to develop a method of manufacturing of heat pipes for heating systems that shall guarantee durable and tight sealing of the heat pipe aluminium profile with the refrigerating gas inside the internal channel of the profile at both sides, which is essential for the devices known from the state of the art operating with the phase transition phenomenon.

The method of manufacturing of heat pipes for heating systems, in which one end is previously tightly sealed with a weld and subjected to the leak test of the joint, whereas the heat pipe itself is filled with gas from the refrigerating gases series according to the invention is characterised by that a single- or a multi-channel aluminium profile of up to 7 m in length of the cross-section of one internal channel within the range from 1 to 900 mm² is installed, ensuring tightness, with the other end in the dosing head with which the gas content of the channel/channels is pumped out to obtain the vacuum of the value from 0 mbar to 100 mbar, and then the gas from the refrigerating gases series is introduced in such an amount that the two phases of the agent are present inside the channel, and then it is moved together with the dosing head to the area of the welding machine electrode and at least one weld, and especially two welds are performed along the external surface of the profile in the distance from 10 to 1000 mm from the dosing head so that the internal channels are flattened and welded, and then the ends of the profile are sealed with a weld, or in a single- or a multi-channel aluminium profile of up to 7 m in length of the cross-section of one internal channel within the range from 1 to 900 mm² a cylindrical opening coaxial with each channel is made, with a conical end of the cone convergence from 0° 5′ to 45° per side to a depth from 5 to 95 mm, and then the aluminium profile is installed in the dosing head dimensionally adapted to the profile to maintain tightness, and the gas content is pumped out to obtain the vacuum of the value from 0 mbar to 100 mbar, and then the refrigerant in the amount sufficient to obtain two physical states is introduced into each internal channel and after being filled with the agent from the inside of the head each internal channel is plugged with a cylindrical element, especially a ball, of dimensions adapted to the performed opening, in such a way that the plugging element is located in the conical section of the opening and settles at the elastic limit of the material, and then, after the disassembly of the dosing head, the aluminium profile is subjected to pressure welding on the welding machine along the external surface to seal the opening that was performed and previously plugged in the distance from the very end up to 3 mm to the plugging element, and then the welded end is sealed with a weld or a single- or multi-channel aluminium profile of up to 7 m in length of the cross-section of the internal channel within the range from 1 to 900 mm² is subjected to the process of making cylindrical openings with a conical end of the cone convergence from 0° 5′ to 45° per side for the distance from 5 to 95 mm, coaxial with each channel, and then the profile is installed in the dosing head dimensionally adapted to the profile to provide tightness with the side subjected to the process of opening making, and then the gas content of the channels is pumped out to obtain the vacuum of the value from 0 mbar to 100 mbar and the channels are refilled with the refrigerant in the amount sufficient to obtain two physical states of the agent, and then the openings made are plugged from the inside of the head with an element dimensionally adapted to the cylindrical opening, especially with a ball, in such a way that this element is located on the elastic limit in the conical section of the opening, keeping the agent in the channels, and after removal from the head, a process opening of the cross-sectional area of 0.1 mm² to 25 mm² is made in the external wall of the profile perpendicularly to the channels axis for the distance sufficient to open all channels in the distance from 15 mm from the end of the profile or not more than 5 mm to the plugging element, and then the ends of the profile are sealed with a weld, and then the process opening that releases shielding gases is sealed.

The method of tight closing of the aluminium profile with gas from the refrigerating series is presented in embodiments.

### EMBODIMENT 1

A multi-channel aluminium profile 1 of the length of 7 m of the cross-section of 900 mm² of one channel 2, previously sealed 3 with the method of welding and subjected to the joint leak test at one of the ends 4, is installed with its other end 5 in the dosing head dimensionally adapted to maintain tightness of the system in which pumping out of the gas content of the channels from the inside of the profile is performed to obtain the vacuum of 50 mbar. Then the gas from the refrigerating gases series is introduced in such an amount that two phases of the agent are present in the channels. The created profile system 1 is transported together with the dosing head under the pressure welding machine electrodes and welds are made along the external surface of the profile in the distance of 10 mm and 30 mm from the dosing head so that the internal channels are flattened and welded 6 sealing the gas inside the profile. After the dosing head is disassembled, the end 5 being the location of the agent introduction is sealed with a weld 7.

### EMBODIMENT 2

In a single-channel aluminium profile 1 of the length of 3.5 m of the cross-section of 900 mm² of the channel 2 sealed with a tight weld 3 at one of the ends 4 an internal cylindrical opening 10 coaxial to the opening 2 with a conical end 8 of the cone convergence of 45° per side to the depth of 55 mm is performed. Then the aluminium profile 1 is installed in the dosing head dimensionally adapted to the profile 1 to maintain tightness and the gas content of the channel is pumped out to obtain the vacuum of 100 mbar, and then the refrigerant in the amount sufficient to obtain two physical states is introduced. After filling with the agent from the inside of the head, the internal channel 2 is plugged with a ball 9 of dimensions adapted to the performed opening 10 so that the ball is located in the conical section of the opening 8 and is settled at the elastic limit of the material. After the dosing head is disassembled, the aluminium profile 1 is subjected to pressure welding on the welding machine so that the internal opening 10 is flattened and welded 6, sealing the gas inside the profile within the distance of 3 mm from the plugging element. After the dosing head is disassembled, the end 5 being the location of the refrigerant introduction is sealed with a weld 7.

### EMBODIMENT 3

A single-channel aluminium profile 1 of the length of 3.5 m of the cross-section of the internal channel of 900 mm² previously sealed by the method of welding 3 and subjected to the leak test of the joint at one of the ends 4 is subjected to the process of making a cylindrical opening 10 coaxial to the channel 2 with a conical end 8 of the cone convergence of 0° 5′ per side for the distance of 95 mm and is installed with the other end 5 in the dosing head dimensionally adapted to maintain the system tightness, through which pumping out of the gas content of the channel from the inside of the aluminium profile 1 is performed to obtain the vacuum up to 0 mbar. Then the aluminium profile 1 is filled with the refrigerant in the amount sufficient to obtain two physical states of the agent, and then the channel 10 is plugged from the inside of the head with a plugging element 9 dimensionally adapted in such a way that this element is located on the elastic limit in the conical section of the opening 8 keeping the agent inside of the channel 2. After removal from the head, a process opening 11 of the cross-sectional area of 0.1 mm² is performed in the external wall of the aluminium profile 1 perpendicularly to the axis of the opening 10 in the distance of 5 mm from the plugging element 9, and then the end 5 is sealed with a weld 7, and then the process opening that releases the shielding gases is sealed with a weld 11.

1. (canceled)

2. A method for manufacturing a heat pipe for a heating system, the method comprising:
providing an aluminum profile comprising an internal channel of a cross-section from 1 to 900 mm² which is sealed at a first end;
making, in the aluminum profile, a cylindrical opening, the cylindrical opening being coaxial with the internal channel and having a conical end;
pumping gaseous content out of the internal channel to reduce pressure in the internal channel to below 100 mbar;
introducing a refrigerant into the internal channel, in an amount sufficient to obtain two physical states of the refrigerant;
plugging the internal channel filled with the refrigerant with a plugging element having dimensions corresponding to the cylindrical opening, by a plugging element fit into the conical section of the cylindrical opening;
sealing the aluminum profile with a weld at a second end of the aluminum profile.

3. The method according to claim 2, wherein the aluminum profile comprises a plurality of internal channels (2).

4. The method according to claim 2, wherein the conical end has a cone convergence from 0° 5′ to 45° per side to a depth from 5 to 95 mm.

5. The method according to claim 2, wherein the plugging element is a ball.

6. The method according to claim 2, further comprising, prior to sealing the aluminum profile with the weld at the second end:
flattening the cylindrical opening; and
sealing the aluminum profile with another weld at the flattened region.

7. The method according to claim 2, further comprising, prior to sealing the aluminum profile with the weld at the second end, making an opening having a cross-section area of 0.1 mm² to 25 mm² in an external wall of the channel, perpendicularly to a longitudinal axis of the channel and letting out shielding gases from the channel.

8. The method according to claim 7, wherein the perpendicular opening is located at a distance of 5 mm from the plugging element.
